(19) United States
(12) Patent Application Publication
(10) Pub. No.: US 2017/0221151 A1
(43) Pub. Date: Aug. 3, 2017

(54) METHOD AND TOOL FOR IDENTIFYING AND CATEGORIZING DAMAGE FOR MOTOR VEHICLES

(71) Applicant: 290 Auto Body Inc., Worcester, MA (US)

(72) Inventor: Justin Earl Forkuo, Worcester, MA (US)

(21) Appl. No.: 15/412,351

(22) Filed: Jan. 23, 2017

Related U.S. Application Data
(60) Provisional application No. 62/289,496, filed on Feb. 1, 2016.

(51) Int. Cl. G06Q 40/08; H04N 7/18

(52) U.S. Cl. CPC G06Q 40/08; H04N 7/185

(57) ABSTRACT

Featured is a method for identifying and categorizing damage to a vehicle including selecting a part, area or region of the vehicle to identify the selected part, region or area; selecting a wand from a device having at least one wand, each wand having a descriptive legend proximal a distal end thereof and positioning the distal end of the selected wand proximal the part, region or area to be identified. The method also includes photographing the selected part, region or area while maintaining the distal end and the descriptive legend within the field of view of an image acquiring device. Also featured is a device for such identifying and categorizing including at least one wand, each wand having a descriptive legend proximal a distal end of the wand. Further featured is a repair method using the information obtained using such a method for identifying and categorizing damage.

This application claims the benefit of U.S. Provisional Application Ser. No. 62/289,496 filed Feb. 1, 2016, the teaching of which are incorporated herein by reference in their entirety.

### FIELD OF INVENTION

The present invention relates to methods, devices and tools for use in identifying damage to motor vehicles that have been damaged such as because of a collision or accident. More particularly, such methods, devices and tools are used for identifying damage and possible repair categories or techniques to motor vehicles that have been damaged. Yet more particularly, such methods, tools and devices are usable for identifying damage and possible repair categories or techniques to motor vehicles that are being restored. Yet even more particularly, such methods are adaptable for use by repair technicians and the like when repairing the motor vehicle.

### BACKGROUND OF THE INVENTION

When motor vehicles have become damaged because of an accident, collision, vandalism or the like, the process can proceed in a number of fashions. In any case, the process initially starts by having an auto body damage appraiser and/or auto damage appraiser, other authorized person or the like (hereafter simply referred to as appraiser) view the damaged vehicle. The appraiser determines the extent of damage to the vehicle and generates an estimate to deal with the damage. From this an assessment is be made whether the damaged vehicle should be repaired or replaced based on the extent of damage to the vehicle. Such a process can include the taking of pictures to substantiate the assessment that was made.

In cases, where the repair (e.g., repair or replacement of parts, areas and/or regions of the vehicle) or the replacement of the damaged motor vehicle is covered by insurance, the auto damage appraiser may be associated with the insurance company or be on a list of authorized appraisers to view damaged vehicles for the insurance company. In such cases, the results of the appraiser's assessment are provided to the insurance company. While a large percentage of cases involving vehicle damage may be subjected to an insurance process, there are cases where the vehicle owner chooses to have the vehicle repaired at their own expense.

This assessment process is not stopped, however, as the initial assessment conducted by the appraiser is typically followed up by further evaluations of the damaged motor vehicle by an experienced individual or appraiser associated with an auto body or vehicle repair shop that can handle the repair of the vehicle. Alternatively, the vehicle owner might approach the auto body or vehicle repair shop to obtain the initial assessment (e.g., no insurance or no insurance claim to be made). The initial assessment of vehicle damage by an appraiser is typically confined to assessing damage that is visually accessible to the appraiser and thus vehicle damage that is not readily accessible visually, may not be identified during the initial assessment.

Consequently, when the motor vehicle is evaluated by the shop's experienced person or appraiser such as when the shop initially removes vehicle structure, additional damage is commonly identified. In the case where the motor vehicle is covered by insurance the insurance related appraiser also is called in to view the additional damage, determine what is required to deal with the damage and determine the estimated additional cost. Another assessment is typically made to again determine if the vehicle should be replaced or repaired (e.g., repair and/or replace parts, areas or regions of the vehicle). As with the initial assessment, this additional process can include the taking of pictures to substantiate the assessment that was made. Such pictures also can be taken by the repair shop for many purposes including memorializing the condition of the vehicle before the repair process is started.

There is found in U.S. D663,355 an ornamental design for a collision damage pointer device showing telescoping segments in an un-extended position. The inclusion of a clip in the design's figures indicates that the device is to be located and stored in a shirt pocket for example before its use. This pointing device, however, is small and includes no information that would assist or help the appraiser, experienced shop person or other person in identifying and categorizing areas, parts and the like of a motor vehicle for likely corrective actions. It merely appears to be a device that a user can use to point at an area, region or part of the vehicle.

General technological advances (e.g., smart phone, digital cameras) have increased the ability of the appraiser and repair shops to take pictures in particular digital pictures or digital photos that can be used to identify the parts of the car which have been damaged as well as showing any damage to the parts. These digital photos can be added to the other digital files maintained for the insurance claim process. Also, some efforts have been undertaken to provide a technique by which the appraiser or repair shop can provide corrective action/repair information or the like on the motor vehicle or parts thereof. However, the known techniques have a number of limitations that effectively limit their use.

One technique, a magnetic collision identification system such as that described by Collision Services, involves mounting a magnetic label having a note or legend thereon on the vehicle which should appear in the photo when it is taken. It is asserted that such a magnetic arrow system will bring attention to and pinpoint types of damage in your photographs thus allegedly making it easy to review and resolve claims. However, these magnetic labels or magnetic arrow system have a number of limitations that effectively limit the use when identifying a damaged part of the vehicle.

As is known to those skilled in the art, the cleanliness of the vehicle's surface affects the ability of mounting such magnetic labels to the vehicle surface. For example, dust, dirt, snow, ice, other environmental debris and the like collect on surfaces of the vehicle during normal use. This debris effectively forms a block to the mounting of magnetic labels. In order to use these magnetic labels, one has to wash or clean the surfaces of the damaged vehicle first so such magnetic labels can be reliably mounted to the vehicle surface. Other surfaces or areas of the vehicle (e.g., frame, springs, etc.) collect dust, grime, dirt, oil, snow, ice, other environmental debris and the like because of their proximity to the ground or other parts of the motor vehicle (e.g., tire wells). Such areas require more aggressive cleaning to expose the metal surfaces before the parts would be capable of mounting a magnetic label. This also assumes at the outset that the mounting surface itself presents a surface which is such that the magnetic label cannot be reliably mounted thereto. Therefore, these magnetic labels are not usable as a practical matter unless the appraiser or repair facility/shop first expends time, money and efforts to clean the vehicle, which is not a likely expectation.

Also, motor vehicle manufacturers are changing the material make-up of the motor vehicles to improve vehicle mileage, to reduce the deterioration of the vehicle structure over time and to improve vehicle performance amongst other reasons. Thus, such manufacturers have begun to use non-magnetic materials such as plastics, aluminum and composite materials in the construction of motor vehicles. For example, to reduce risk of corrosion and/or weight, it is not uncommon to see plastic materials used for vehicle parts that can be exposed to materials (e.g., sand and salt combinations used on roads) that would attack steel parts. As a result of these efforts, a large percentage of vehicle parts are now made of non-magnetic materials. In addition, there are parts of the car (e.g., car seats or seat coverings), which include non-magnetic materials (e.g., leather seat coverings). Consequently, the magnetic labels cannot be mounted to these parts of the car and thus are not usable for identification purposes.

Another conventional device or methodology involves the use of a marker type of device (e.g., Auto Writers by Collision Services) which allows the user to write on the parts, regions or areas of the vehicles to leave notes and instructions anywhere on the vehicle as it passes through the repair process (e.g., see FIG. 10). It is asserted that one can write on auto finishes, glass and acrylics without damage and wipes off easily with a glass cleaner. As with the magnetic label type of device, the surface one wants to write on must be clean enough to write on. Also, such markers cannot be used to write on certain surfaces or parts of the vehicle that would become damaged if the marker is used (e.g., seats and their seat coverings). Therefore, these markers have limited usability for example, unless the appraiser or repair facility/shop first expends time, money and efforts to clean the vehicle. Also, these markers that can be used to provide messages tend to be subjective or understood by the repair shop and thus are not easily related to a given repair modality or process (e.g., should damaged part shown in FIG. 10 be repaired or replaced).

It thus would be desirable to provide new tools or methods that could be used in identifying damaged parts, areas and the like of a motor vehicle without regard to the material make-up of such vehicle parts, areas and the like. It would be particularly desirable to provide such tools, device and methods that also would be capable of providing an indication of possible repair techniques for handing the damaged parts, areas or the like. It also would be desirable to provide such tools, device and methods which would be capable of locating a minimal distance from the damage for taking pictures (e.g., digital photos) of the damaged point, area or part. Such tools and/or device preferably would be simple in construction and less costly than prior art devices (if any) and such methods would not require highly skilled users to utilize the device/tool when identifying and categorizing a damaged area, region or part.

### SUMMARY OF THE INVENTION

The present invention features a method and device for identifying and categorizing damage to a vehicle. According to one aspect of the present invention, such a method includes selecting one of a part, area or region of a motor vehicle to identify one of the part, region or area and selecting a given wand from a device comprising at least one wand, each of the at least one wand having a descriptive legend proximal a distal end of the wand. The method further includes positioning the distal end of the given wand proximal the selected part, region or area and photographing the selected part, region or area of the vehicle while maintaining the distal end of the given wand and the descriptive legend within the field of view of a device that is configured to acquire images. Such a descriptive legend can comprise an action to be taken with respect to the part region or area being identified.

In further aspects/embodiments, the device comprises one of a plurality of wands or a multiplicity of wands, where the descriptive legend is different for each wand.

In yet further aspects/embodiments, the at least one wand or each of the wands of the device is further configured to include one or more descriptive legends and/or indicia thereon that can be photographed or imaged preferably at the same time. Such indicia or legends includes digital images or images including digital data or information that can be read using an appropriate reader application. In more particular embodiments/aspects the wand is configured so as to include a plurality of such descriptive legends and/or indicia.

In yet further aspects/embodiments, such a method includes determining after said photographing if there is another part, area or region of the vehicle to identify. If said determining determines that there is another part, region or area to identify (i.e., Yes) then the method includes repeating said steps of selecting another wand having a descriptive legend that relates to the another part, area or region to identify, positioning the distal end of the another wand proximal the selected part, region or area; and photographing the selected part, region or area of the vehicle while maintaining the distal end of the another wand within the field of view of the device taking the photograph. If on the other hand, it is determined that there is no more parts, regions or areas to identify; then the method further includes ending the process of identifying and categorizing the one or more parts, areas, and regions of the vehicle.

In yet further aspects/embodiments, the method further comprises the step of positioning the image acquiring device based on using a predetermined length of the wand.

In yet further aspects/embodiments, the image acquiring device comprises one of digital camera or a smartphone.

According to another aspect of the present invention there is featured a tool for identifying and categorizing damage to a motor vehicle. Such a tool includes at least one wand. Each of the at least one wand includes a descriptive legend proximal a distal end of the wand.

In further aspects/embodiments, such a tool includes a plurality or a multiplicity (three or more) of wands. In yet further aspects/embodiments, the descriptive legend is different for each wand.

In yet further aspects/embodiments, the at least one wand or each wand of the device is further configured to include one or more descriptive legends and/or indicia thereon that can be photographed or imaged preferably at the same time. Such indicia or legends includes digital images or images including digital data or information that can be read using an appropriate reader application. In more particular embodiments/aspects the wand is configured so as to include a plurality of such descriptive legends and/or indicia.

In yet further aspects/embodiments, such a tool further includes an image acquiring device. Such an image acquiring device includes one of a digital camera or a smartphone.

In yet further aspects/embodiments, each wand has a predetermined length. The predetermined length is established for purposes of positioning the image acquiring device at a desired location with respect to the part, area or region to be identified using the tool. In other aspects/embodiments, the predetermine length is established based on the intended user of the device. For example, if the device is to have a measure of portability it may be configured with a shorter length as compared to the one providing guidance to locating the image acquiring device.

In yet further aspects of the present invention there is featured another method which uses the photographs, digital images and/or other information obtained using the methods and devices described hereinabove in connection with the repair of a vehicle/motor vehicle that has become damaged. More specifically, as the photographs or digital images identify the damaged part, region or area of the vehicle/motor vehicle as well as identify the repair modality by means of the descriptive legend provided on the wand, also in the photo/digital image, the body shop or repair shop can readily determine what parts/areas/regions of the vehicle are to be replaced, removed, repaired and installed or the like, before they begin to work on the vehicle. This also allows the body or repair shop to determine the parts, materials or material requirements and resources (e.g., tools, equipment) needed to perform the repair of the damaged vehicle as well as order such parts, materials, equipment and/or tools and the like in advance to facilitate the repair process. Such photographs, digital images or the like also can be utilized by the repair technician in planning for and repairing the vehicle/motor vehicle.

In more particular embodiments, such a repair method includes an initial evaluation of the photographs, digital images or the like that were obtained using the devices and damage identifying methods of the present invention, as herein described, to determine the damage and the repair modality as identified on the provided photos, digital images or the like. This can include electronic transfer and/or printing out on or more physical copies of such photos, digital images or the like. Such photos, digital images and the like also can be used by the body/repair shop to determine a plan for the vehicle repair. Such a plan can include the ordering of the actions to be take such as the removal or parts, areas of regions of the vehicle that are to be replaced or installed after repairing/painting.

As indicated herein, when the body/repair shop begins to deconstruct or disassemble the vehicle/motor vehicle it is not uncommon for the body/repair shop to discover additional damage to the vehicle. Thus, in addition to identifying such additional damage using the devices and methods of the present invention, the body/repair shop using this additional information can appropriately modify its repair plan as well as ordering any additional parts and/or materials for repairing such additional damage.

In further embodiments, the body/repair shop also can use the photos, digital images or the like as well as any additional information acquired to develop checklists, punch lists or the like that can be used by the repair technician such as in determining if the repair process has been completed. Further, the repair process or methodology of the present invention can further include taking photos, digital images and the like of the repaired vehicle corresponding to the vehicle locations which had been damaged/repaired to document the corrective actions taken.

Other aspects and embodiments of the invention are discussed below.

### Definitions

The instant invention is most clearly understood with reference to the following definitions:

USP shall be understood to mean U.S. patent Number and U.S. Publication No. shall be understood to mean U.S. Published patent application Number.

The terms “comprising” and “including: as used in the discussion directed to the present invention and the claims are used in an open-ended fashion and thus should be interpreted to mean “including, but not limited to.” Also, the terms “couple” or “couples” is intended to mean either an indirect or direct connection. Thus, if a first component is coupled to a second component, that connection may be through a direct connection, or through an indirect connection via other components, devices and connections. Further the terms “axial” and “axially” generally mean along or substantially parallel to a central or longitudinal axis, while the terms “radial” and “radially” generally mean perpendicular to a central, longitudinal axis.

Additionally, directional terms such as “above,” “below,” “upper,” “lower,” etc. are used for convenience in referring to the accompanying drawing figures. In general, “above,’ “upper,” “upward” and similar terms refer to a direction toward a proximal end of an instrument, device, apparatus or system and “below,” “lower,” “downward,” and similar terms refer to a direction toward a distal end of an instrument, device, apparatus or system, but is meant for illustrative purposes only and the terms are not meant to limit the disclosure.

Reference to a singular item, includes the possibility that there are plural of the same items present. More specifically, as used herein and in the appended claims, the singular forms “a,” and, “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs.

Motor vehicle as that term is used herein shall be understood to mean any motorized vehicle (e.g., gasoline, diesel, and/or electrical powered vehicle) that operates on a road or surface and shall further include automobiles, cars, pick-up trucks, sport utility vehicles (SUVs), motorcycles as well as commercial vehicles including trucks and buses.

Damage to a vehicle such as motor vehicles as that term is used herein shall be generally understood to encompass or mean a vehicle/motor vehicle which has become damaged as a result of a collision, accident, vandalism or the like. Such damage also shall be understood to include an original equipment manufacturer (OEM) defect or the like. Damage also shall be understood to include damage to a vehicle, including parts, areas or regions thereof resulting from the aging of such vehicle including parts, areas and/or regions thereof, such as may be found when restoring such a vehicle. Such damage can take any of a number of different forms and also reflect different levels of severity of damage to the vehicle/motor vehicle. An example of a simple or low level of severity includes but is not limited to cosmetic damage to the vehicle (e.g., keying of the exterior surface(s) of the vehicle or scratches). An example of a severe level or extensive damage to the vehicle can include, but is not limited to damage to one or more of the structure, frame, exterior, interior and/or systems (e.g., engine, drive train, electrical systems, fluid systems or A/C systems) of the vehicle. OEM defects can include damage to components or systems of the motor vehicle such as suspension and steering components, fluid systems components (air conditioning related piping and operating components), electrical components as well involving the replacement of vehicle structure, interior structure and components and vehicle panels (e.g., fender, bumper, etc.).

Auto damage appraiser or auto body damage appraiser shall be understood to generally mean a person that is licensed, certified or otherwise authorized to assess a motor vehicle that has been damaged and/or to generate or provide an estimate of the cost to repair the damage to the vehicle. Such a person may be licensed or certified for example, by local or state authorities as well as any other practice known in the art.

A QR code (or Quick Response code) as is known to those skilled in the art is a type of matrix barcode or two-dimensional barcode first designed for the automotive industry in Japan. A QR barcode uses four standardized encoding modes (numeric, alphanumeric, byte/binary, and kanji) to efficiently store data; extensions may also be used. The required data are then extracted from patterns that are present in both horizontal and vertical components of the image. Unlike the older, one-dimensional barcodes that were designed to be mechanically scanned by a narrow beam of light, a QR code is detected by a 2-dimensional digital image sensor and then digitally analyzed by a programmed processor. The processor locates the three distinctive squares at the corners of the QR code image, using a smaller square (or multiple squares) near the fourth corner to normalize the image for size, orientation, and angle of viewing. The small dots throughout the QR code are then converted to binary numbers and validated with an error-correcting algorithm.

The terms auto body or vehicle repair shop as used herein shall be understood to be generally describing or referring to a facility, center, shop (e.g., body shop), operating unit of a larger vehicle facility (e.g., car dealership selling, maintaining and/or repairing vehicles), collision center, restoration shop, whose purpose is to repair and/or restore vehicles such as motor vehicles which may have become damaged as a result of, but not limited to collision, accident, vandalism, original equipment manufacturer defect, aging and/or the like. Thus, the present invention shall not be understood to be limited to use by facilities specifically identified as an auto body shop or vehicle repair shop.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIGS. 1A-D are various views of a device or tool according to one aspect of the present invention, where FIG. 1A is a top view, FIG. 1B is a side view, FIG. 1C is an end view and FIG. 1D is a side viewing showing the individual wand when fanned out.

FIG. 2 is an illustrative view showing the distal ends of the individual wands depicting the descriptive legend associated with each wand.

FIG. 3 is an illustrative view of an exemplary mobile phone stent usable along with the device or tool of the present invention.

FIGS. 4A-C are various views of a wand for use as a device or tool according to another aspect of the present invention, where FIG. 4A is an end view; FIG. 4B is a top view and FIG. 4C is another top view but illustrating a region for providing the descriptive legend associated with the wand.

FIG. 5A-E are various views of a wand (a four sided wand) for use as a device or tool according to yet another aspect of the present invention, where FIG. 5A shows an end view and FIGS. 5B-5E show respective side views of the wand.

FIG. 6 illustrates a high level process diagram of a methodology according to one aspect of the present invention.

FIGS. 7A-I are various illustrative views showing use of the device or tool of the present invention to identify parts, regions or areas of a motor vehicle and categorizing the possible repair technique, repair procedure, corrective action or the like when taking photos of the identified vehicle part, region, or area.

FIGS. 8A-C are various illustrative views of a color chart including a color code of the wand corresponding to the indicia or various descriptive legends in any of a number of languages such as English (FIG. 8A), French (FIG. 8B) or Italian (FIG. 8C).

FIG. 9 is an illustrative view of a wand for use as a device or tool according to yet another aspect/embodiment of the present invention illustrating where the wand includes more than one area (e.g., a plurality of areas) each having indicia/descriptive legends.

FIG. 10 is a pictorial view showing use of a conventional marker type of device writing on a part, region or area of a vehicle so as to leave notes and/or instructions.

### DESCRIPTION OF THE PREFERRED EMBODIMENT

Before the present invention is described in detail, it is to be understood that this invention is not limited to the particular variations set forth and can, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

Herein reference is made to vehicles such as motor vehicles which have become damaged as a result of a collision, accident, vandalism, aging, original equipment manufacturer (OEM) defect or the like. As described herein, such damage can take any of a number of different forms and also reflect different levels of severity of damage to the vehicle/motor vehicle. An example of a simple or low level of severity includes but is not limited to cosmetic damage to the vehicle (e.g., keying of the exterior surface(s) of the vehicle or scratches). An example of a severe level or extensive damage to the vehicle can include, but is not limited to damage to one or more of the structure, frame, exterior, interior and/or systems (e.g., engine, drive train, electrical systems, fluid systems or A/C systems) of the vehicle. Such damage also can include an OEM defect to components or systems of the motor vehicle such as suspension and steering components, fluid systems components (e.g., air conditioning related piping and operating components), electrical components as well involving the replacement of vehicle structure, interior structure and components and vehicle panels (e.g., fender, bumper, etc.). As such, the present invention shall not be understood as being particularly limited to particular forms or types of damage.

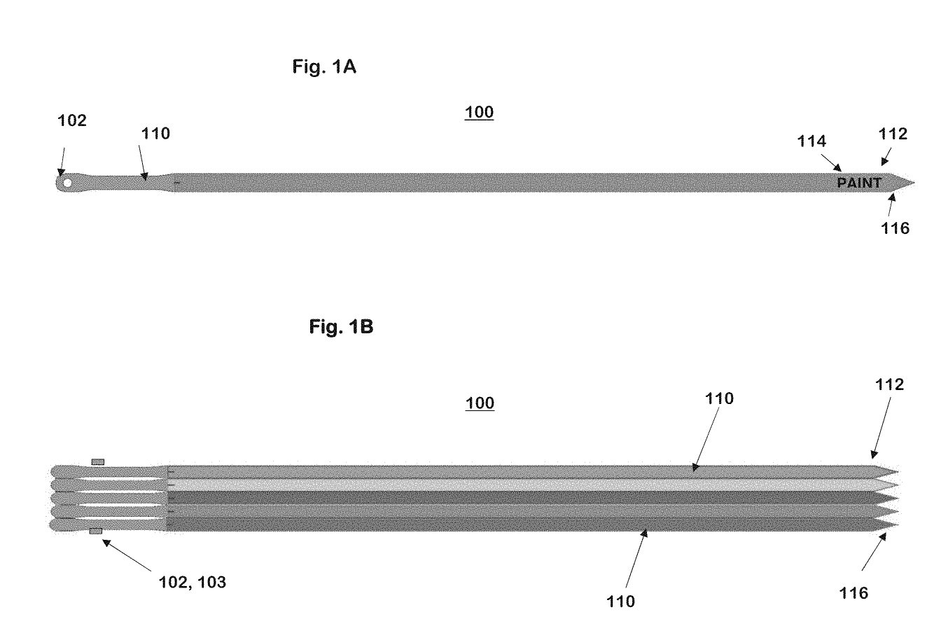

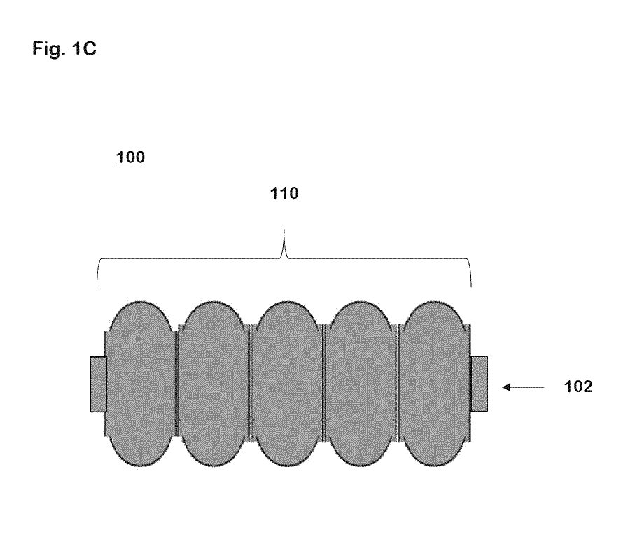

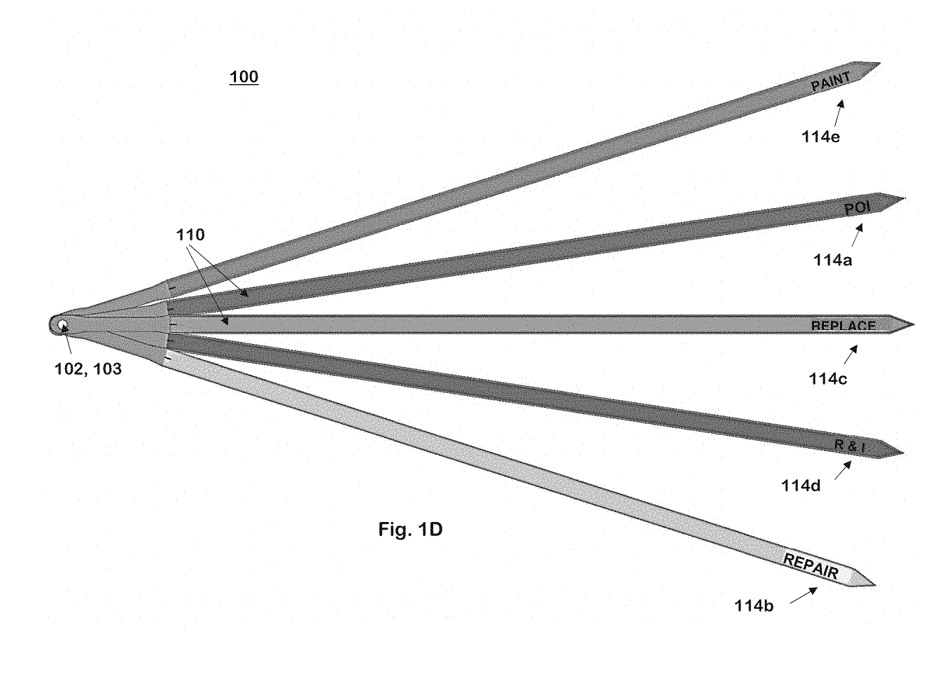

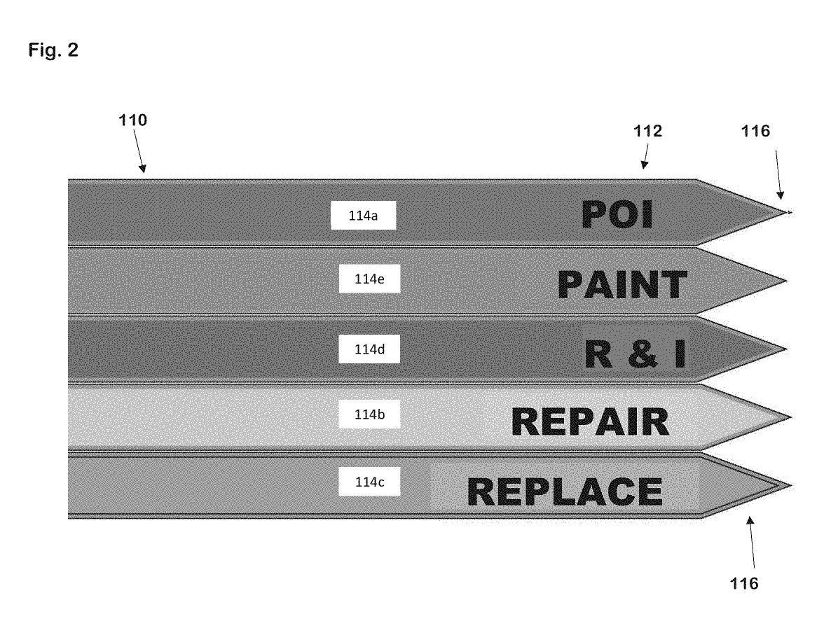

Referring now to the various figures of the drawing wherein like reference characters refer to like parts, there is shown in FIGS. 1A-D various views of a device or tool 100 according to one aspect of the present invention, where FIG. 1A is a top view, FIG. 1B is a side view, FIG. 1C is an end view and FIG. 1D is a side viewing showing the individual wands 110 when they are fanned out. Reference also should be made to FIG. 2 which provides an illustrative view showing the distal ends 112 of the individual wands that depict or show the descriptive legend 114 (e.g., 114a-e; FIG. 2) associated with a given wand.

Such a device or tool 100 includes at least one wand and more particularly, a plurality or a multiplicity (three or more) of wands 110. In more particular, exemplary embodiments, such a tool includes four or five or more such wands. The number of wands is determined by the particular usage of the device or tool. For example, the number and type of current possible corrective actions for repair of motor vehicles damaged in a collision or accident or by vandalism can number about four or five such corrective actions. Thus, the tool as illustrated in FIG. 1A can include four or five wands. Such a tool can be adapted for use in identifying and categorizing repairs for other parts of the motor vehicle (e.g., transmission, suspension) as well as other types of vehicles (e.g., trucks, trains, airplanes, construction vehicles).

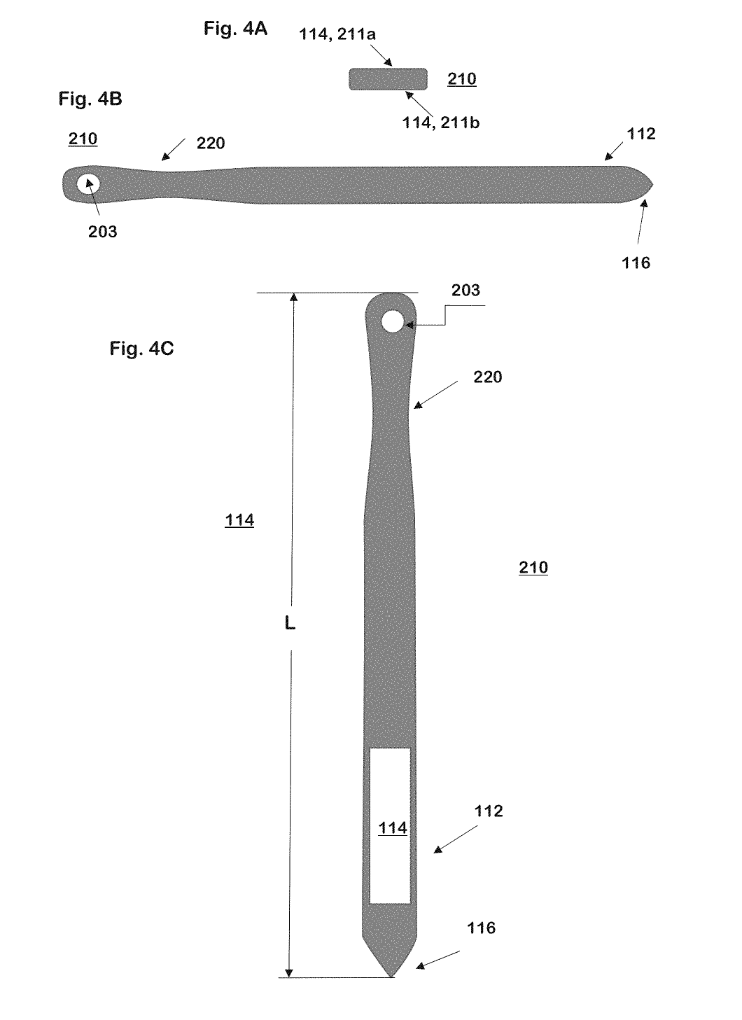

The individual wands 110 of the tool can be arranged so as to be movably joined by a moving or pivoting mechanism 102 such as a pivoting metal or plastic mechanism as are known in the art. For example, such a mechanism can comprise a nut and bolt (e.g., see FIG. 1C) that are arranged so that the bolt extends through an aperture 103 or through hole disposed in a proximal end of each wand (e.g., see also FIG. 4A). The nut is secured to an end of the bolt so the wands do not generally move axially along the bolt and so that they are pivotally mounted on the bolt. In this way, a user can select a specific wand by pivoting the selected wand about the bolt so as to separate it from the other wands. This pivoting mechanism 102 or pivoting connector allows the wands 110 to easily be kept or stored together while allowing them to be used one at a time as needed. Also, the wands are arranged so that they can fan out from the point of the pivoting mechanism 102. As indicated hereinafter, in alternative embodiments such a device can be made up of individual wands that are not movably joined.

In more particular embodiments, the wands are composed of any of a number of materials that are appropriate for the intended use including wood and plastic. As indicated above, each wand, the proximal end thereof, is preferably configured (e.g., see FIGS. 4A, B) so as to include a through aperture 103 to receive the pivoting mechanism 102. As also described further herein, such wands also are configurable so that the descriptive legends 114 are located on opposing surfaces of the wand so that the wand is easily usable by either a left or right hand.

The distal end 112 of the wand 110 is configured so as to include a pointing tip 116 such as for example a dull pointed tip. As described herein, the user can locate and arrange the wand such that when it is in the desired positioned the pointed tip is pointing at the part, area or region of the motor vehicle thereby identifying the particular part, area or region of the motor vehicle.

In further embodiments, the descriptive legend 114 or region is provided on the wand close to the distal end that more specifically identifies the corrective action or procedure category that applies to the identified part, region or area. In this way, the wand both identifies the applicable part, region or area as well as providing the procedure category or corrective action that applies to the identified part, region or area. Thus, when a photo is taken with the wand appearing in the photo, the photo thereby provides a visual representation of the area, region or part of the motor vehicle including the wand which identifies the particular part, region or area and the corrective action or procedure category that applies.

In particular exemplary embodiments, each wand is labeled with one of the below described categories that describes the damage and/or procedure needed. One wand can be configured so as to include a Repair (Rpr) legend 114b which is used to identify items that will be repaired. Another wand can be configured so as to include a Replace (Repl) legend 114c which is used to identify items that will be replaced. Yet another wand can be configured so as to include a Paint (Refn) legend 114e which is used to identify items to be painted, refinished, blended, or clear coated. Yet another wand can be configured so as to include a Remove & Install (R&I) legend 114d which identifies items that will be taken off and then put back on the vehicle. Yet another wand can be configured so as to include a Point of Interest (POI) legend 114a which identifies possible damage or misalignment identified but unclear.

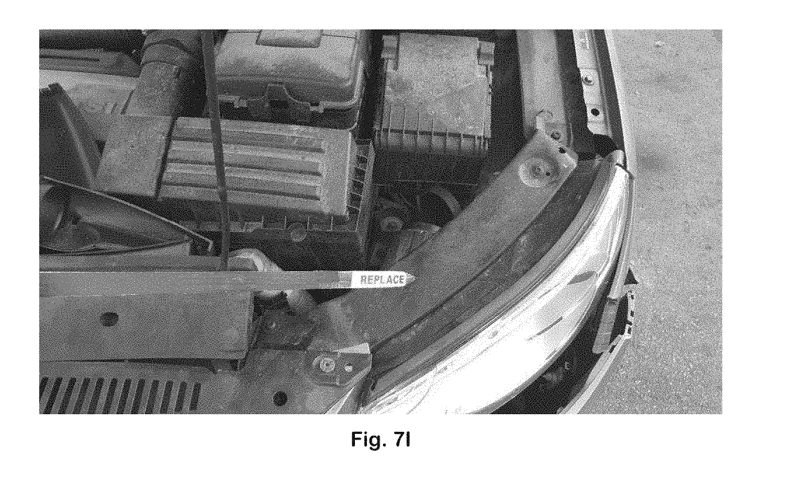

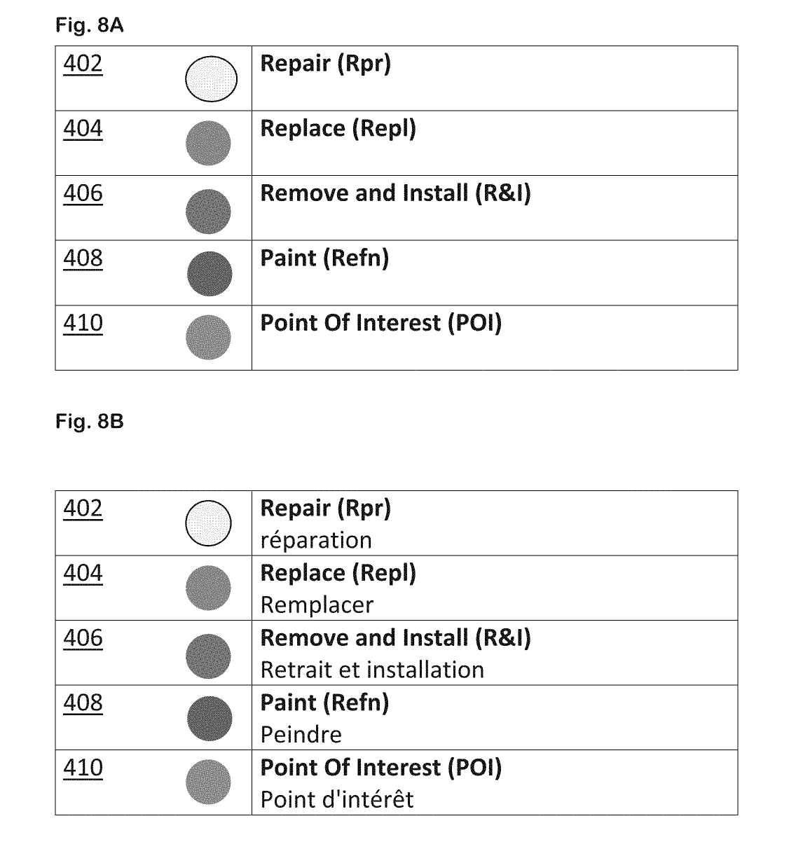

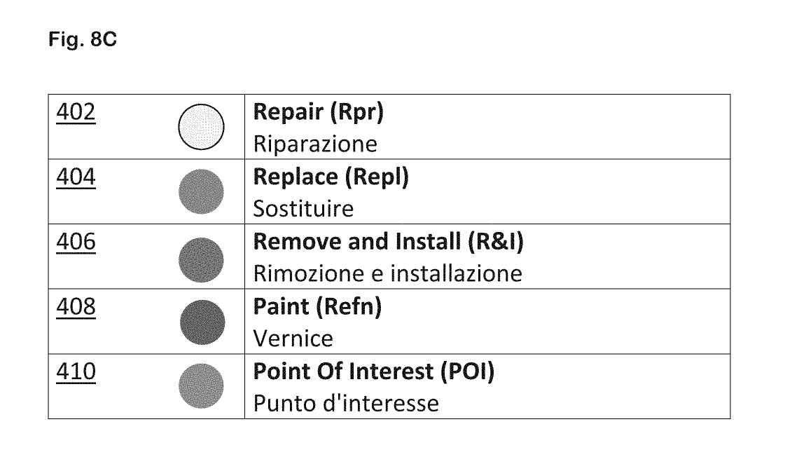

In yet further embodiments, the wands, at least the distal portion of the wand 110 including the descriptive legend 114 include a color code that corresponds to the procedure category or corrective action provided in the descriptive legend. In exemplary embodiments, a wand with a Repair (Rpr) legend 114b can include a YELLOW color code (402, FIG. 8A); a wand with the Replace (Repl) legend 114c can include a GREEN color code (404, FIG. 8A); a wand with the Paint (Refn) legend 114e can include a LIGHT BLUE color code (406, FIG. 8A); a wand with the Remove & Install (R&I) legend 114d can include a RED color code (408, FIG. 8A) and the Point of Interest (POI) legend 114a can include a PINK color code (410, FIG. 8A). It should be recognized that these color combinations are illustrative and that another color(s) can be used, for example, an Orange color can be used in lieu of the PINK color.

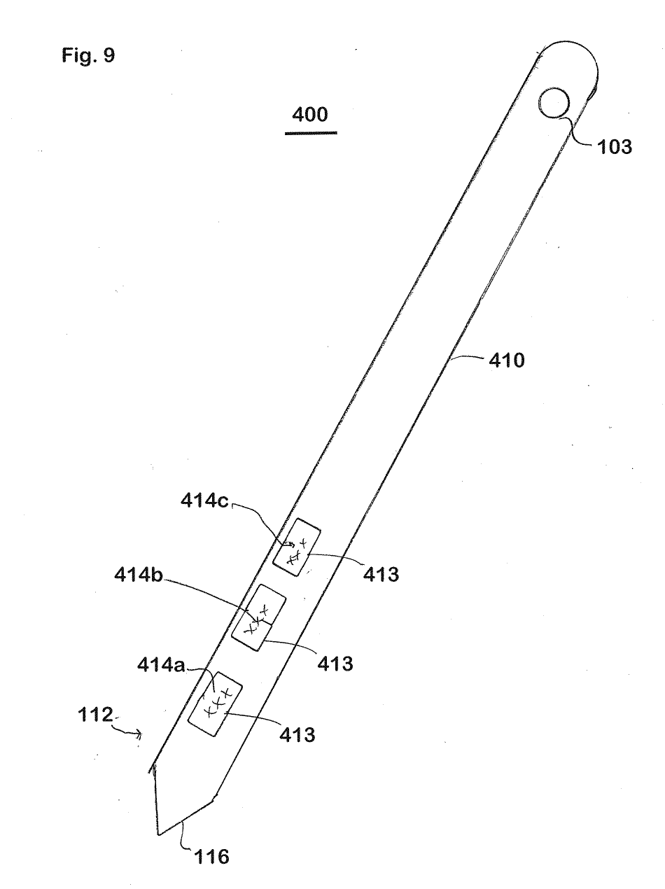

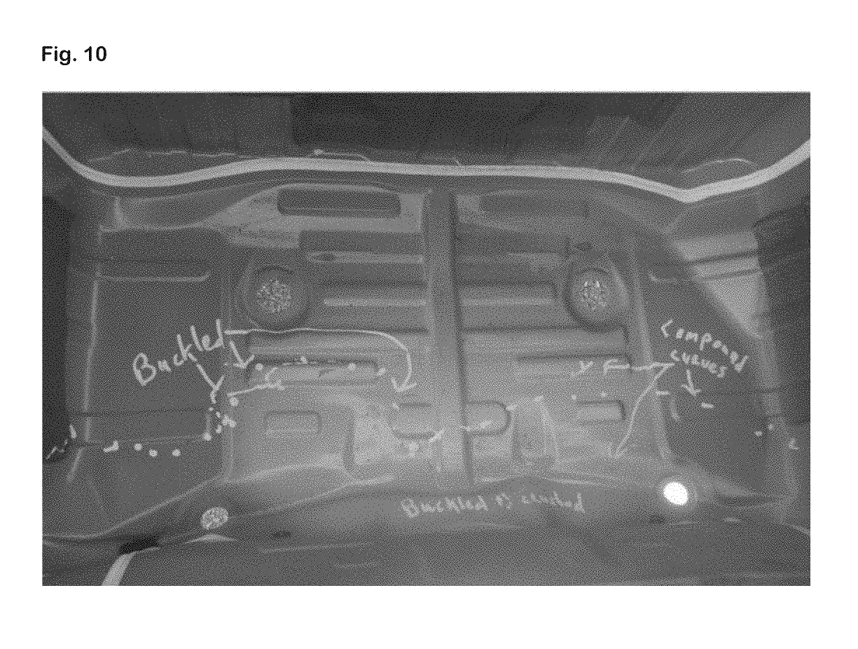

Referring now to FIG. 9, there is shown a device 400 including a wand 410 according to further aspects/embodiments of the present invention. Herein reference numeral 110 is used to generally describe a wand that is usable with a device 100 according to the present invention. However, the present invention is not so limiting and it shall be understood that it is within the scope of the present invention for any of the wands 110, 210, 410 described herein to be used in connection with any of the devices also described herein.

Such a wand 410 according to this aspect/embodiment of the present invention is configurable so as to include one or more areas 413 that have indicia 414a-c provide therein. More particularly such a wand includes a plurality of such indicia containing areas and more specifically a multiplicity (i.e., 3 or more) of such indicia containing areas. The indicia 414a-c contained in such areas 413 comprises one of a descriptive legend 114 as described above, other visually descriptive information and/or readable digital information such as a barcode or other machine readable digital code.

Without limiting the present invention to the illustrated embodiment, in illustrated examples, reference numeral 414a shall be understood to be referring to a descriptive legend 114, reference numeral 414b shall be understood to be referring to other visually descriptive information and reference numeral 414c shall be understood to be referring to other machine readable digital code or information. It shall be understood that such a wand 410 is configurable to include a descriptive legend 414a and other visually descriptive information 414b, a descriptive legend 414a and other machine readable digital code or information 414c as well as only a descriptive legend 414a, only other visually descriptive information 414b and only other machine readable digital code or information 414c.

Such other visually descriptive information 414b includes information that is used to provide further descriptive details of the damaged part, region or area including a description of the type of damage. More particularly, such other visually descriptive information 414b in combination with the descriptive legend 114 can be used to more fully describe the type of damage as well as the procedure category or corrective action (e.g., repair modality) represented by the descriptive legend to deal with the damage. For example, in the case of a part which is identified by a wand with a “Repair” descriptive legend, the other visually descriptive information could be used to indicate or identify more particularly the type of damage such as for example a buckle. In this way, one can conclude from a single image or photograph (e.g., digital photograph) including the wand 410 that the buckle shown in the identified part is to be repaired.

Such other machine readable digital code or information 414c can be configured and arranged so as to provide more details of the part, region or area being identified by the wand including also, for example, the repair modality of the wand being imaged. In more particular embodiments, such digital code or information further includes information identifying the specific vehicle and/or the vehicle owner. More particularly, the other readable digital information includes digital characters or information that represents one or more of, the vehicle (type, make and years), the vehicle owner, the insurance carrier, the repair modality for the part, region or area being shown in the image or photograph and providing an identifier for the specific image/photograph. In exemplary embodiments, such other machine readable digital code or information 414c includes for example a QR type of barcode.

In this way, using any of a number of known techniques or those hereinafter developed for optically reading such digital information, it may be possible to input the digital information directly into an electronic record cataloging or reporting the damage. This can eliminate or minimize manual inputting of information based on a person reading the image or photograph as well as reducing the potential for inputting error.

In further embodiments, each wand 110 or each wand of a device 100 embodying more than one wand, is configured and arranged so as to have a predetermine length that is selected from any of a number of lengths as are known to those skilled in the arts and otherwise appropriate for the intended use. In particular embodiments, each wand 110 is configured and arranged so as to have a predetermined length that is established so that it defines a desired length from the vehicle to a location of the digital camera or smart phone being used to take the photo(s). In illustrative exemplary embodiments, the length of the wand when used with smartphones is in the range of from about 30 to about 40 inches and in a more particular embodiment is about 36 inches. In this way, a minimal distance or an optimal distance to the targeted part, are or region of the vehicle is established or defined so that the picture is taken not too close or too far away from the targeted location. One common problem that occurs when taking the digital photo is that the camera or smart phone is too close to the targeted location or too far away such that the damaged area is not properly shown on the photo. For example, when too far away, the damaged area is not readily discernable from the rest of the vehicle structure (e.g., one does not have a photo depicting the dented fender from an accident).

In yet further embodiments, the predetermined length of the wand can be established with a short length so as to be portable and thus usable by those persons such as for example insurance adjusters, where the size of the wand could be a consideration because of the need for portability. For example, for people who travel to different locations to view damaged vehicles there is a need to make any instruments, tools and/or imaging devices have a desirable amount of portability in order for the instrument, tool or imaging device to be of practical use. In such cases, the portability of the wand does involve some amount of training in its use so as to ensure that the area, part or region of the vehicle being imaged is an appropriate distance from the imaging device. For example, by training one can be taught to extend the arm outwardly from the wand and to use the extended arm for positioning the imaging device from the point of interest. In an exemplary illustrative embodiment, such a wand has a length of about 6 inches or more and more particularly, a length in the range of from about 6 inches to about 12 inches. The length of the wand also is selected such that it can contain at least one area having a descriptive legend therein.

In yet another embodiment, such a wand can be configured with a medium length that is longer than the above described short type of wand but shorter than the wand used to establish a desired length from the vehicle for imaging. The length of the wand also is selected such that it can contain at least one area and preferably more than one area having a descriptive legend and/or indicia therein. While it may not be as long as the length of the wand specifically optimized for vehicle imaging, the length is such that a user can use the medium length wand to position the imaging device from the vehicle for imaging. In particular illustrative embodiments, such a medium length wand had a length of about 18 inches, more particularly, a length of about 18 inches to about 24 inches.

In yet further aspects/embodiments of the present invention, the wands of the present invention can be used in combination with other mechanisms or devices, such as those that are known to those in the art, to further the use and understanding of the wands and descriptive legends of the present invention. Also, while the foregoing describes the use of the wand of the present invention to identify descriptive legends that described repair or work modalities, it also is within the scope of the present invention that a wand be configured so as contain or provide other legends or information to further describe the type of damage (e.g., buckle, scratch, crease, tear or the like). As described herein, such a wand can contain such other legends or other information alone or in combination with a descriptive repair modality legend.

In more illustrative exemplary embodiments, the wands of the present invention can be used in combination with colored indicia that can be removably affixed to the part, region or area of the vehicle containing damage (e.g., a colored adhesive label). Such colored indicia can be coordinated with a color associated with a given wand and associated repair modality such that a repair technician can easily determine the repair modality (e.g., repair, remove and replace, paint) that is intended for the identified part, region or area. As also indicated above, other devices, mechanisms and indicia as are known in the art may be used in a similar fashion to provide messages, instructions, information and the like to the repair technician as assistance with the intended repair.

Referring now to FIGS. 8A-C there are shown various illustrative views of a color chart 400 or the like listing the various descriptive legends in any one of a number of languages and the color codes 402-410 provided on the wands. Such languages include English (FIG. 8A); French (FIG. 8B), Italian (FIG. 8C), Spanish, Greek, Albanian, or Vietnamese. In addition, the color chart can be configured and arranged so as to include descriptive legends in more than one language such as for example English and Spanish. Such a chart can be configured and arranged as a wall chart that is mounted to a wall or other structure to present the chart vertically as well as being replicated in a book, replicated on a sheet of paper or provided in digital form to accompany any digital photos of a vehicle or the like.

While one use of the device or tool 100 of the present invention is for use when photographing to point out damage on a vehicle, it is not limited to such uses. For example, such a device or tool 100 can be used in a training setting for an automotive teacher to point out damage (real or assumed) or for use in a training setting for a trainee to practice and increase skills in pointing out damage.

Referring now to FIGS. 4A-C, there is shown various views of a wand 210 for use with a device or tool according to another aspect of the present invention, where FIG. 4A is an illustrative end view, FIG. 4B is an illustrative top view and FIG. 4C is another illustrative top view with a region for providing the descriptive legend associated with the wand. As with the wand 110 described above, such a wand according to this aspect/embodiment of the present invention includes a distal end 112 and a pointed tip 116. Reference shall be made to the discussion above regarding the distal end and pointed tip as shown in FIGS. 1A-D for details not provided below. Reference also should be made to the above discussion for details of the descriptive legend 114 and color coding as well.

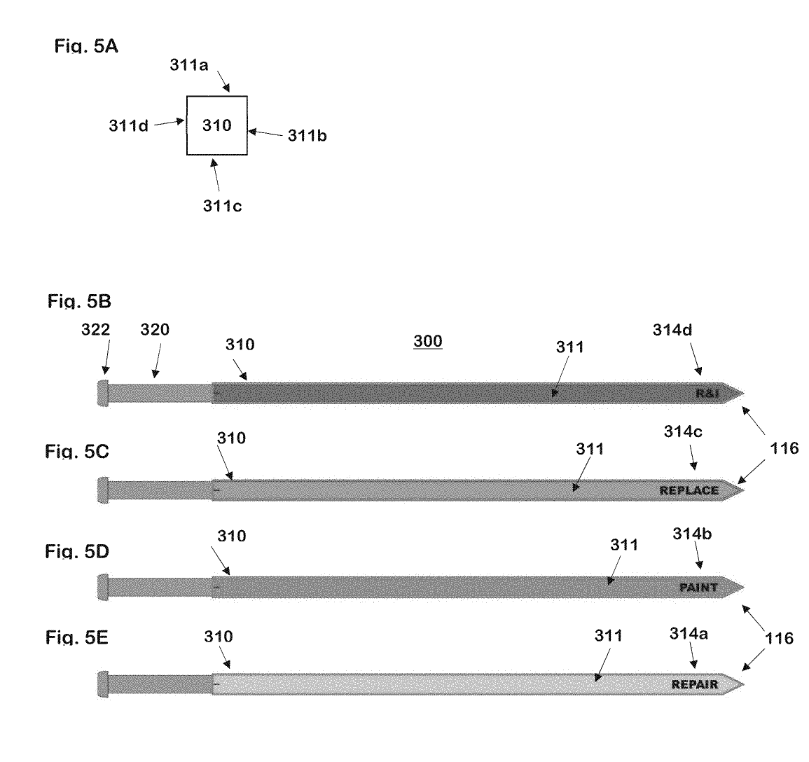

Such descriptive legends can be arranged in any of a number of configurations such as being arranged so as to be on one surface of the wand as illustrated in FIGS. 1A-D or the wand 210 (FIG. 4A) can be arranged so that a descriptive legend is provided opposing surfaces 211a,b of the wand. With reference also to FIGS. 5A-E, such a wand can include multiple surfaces and different descriptive legends can be provided on one or more of these multiple surfaces. In further embodiments, the descriptive legend provided on the two opposing surfaces is the same legend so as to allow the wand to be easily used by a right handed or left handed person or so that the wand can be adapted to point at one area, region or component from one direction and then be used to point at another area, region or part from another direction while maintaining the general orientation of the legend. In yet further embodiments, the wand can be configured so that the wand includes a different descriptive legend on each of the opposing surfaces.

The proximal end of such a wand 210 includes a through aperture 203. In one embodiment a plurality or a multiplicity of such wands are secured to each other using a pivoting mechanism 102 such as described above. In an alternative embodiment, a plurality or multiplicity of hooks or other devices (e.g., screws, nails, etc.) are secured to a wall, stand or other such device. In such an alternative embodiment, each of the wands 210 being provided are removably mounted to the wall or the like by removably securing each wand to the hook or other device. In use, the user would unhook or remove the desired wand from the hook or other device, and position it as described above so the pointed tip is aimed at the part, region or area to be identified and so the descriptive legend is visible in the photo to be taken. After taking the photo, the user would return the selected wand to the appropriate hook for storage until another use of the wand.

In further embodiments, a proximal end portion 220 of the wand 210 also is configured so as to provide an area (e.g., dished area) that is configured and arranged to facilitate the gripping action of the user. This is done to facilitate the user's holding of the wand while taking photos. In yet further embodiments, each wand 210 is configured and arranged so as to have a predetermined length (L) that is established so that it defines a desired length from the vehicle to a location of the digital camera or smart phone being used to take the photo(s). In this way, a minimal distance or an optimal distance to the targeted part, are or region of the vehicle is established or defined so that the picture is not too close or too far away from the targeted location.

Referring now to FIGS. 5A-E there are shown various views of a wand 310 for use as a device or tool 300 according to yet another aspect of the present invention, where FIG. 5A shows an end view of such a wand and FIGS. 5B-5E show respective side views of the wand. This wand 310 is configured and arranged so as to present a plurality or a multiplicity of sides 311. The number of sides is determined or established based on the number of legends the wand is to be capable of displaying. Thus, while a square shape is illustrated such a wand can be configured so as to present any of number of end shapes, including 3 or more sides such as trapezoids, triangles (3 sides), pentagons (5 sides), hexagons (6 sides), and octagons (8 sides). In use, the user would rotate the wand to the side showing the appropriate descriptive legend.

In a more particular exemplary illustrative embodiments (see FIG. 5A), the wand 310 is configured and arranged with four sides 311a-d. According to this aspect of the invention, each side of the wand is configured and arranged so as to present a descriptive legend of a given corrective action or procedure category. In the illustrated embodiment, the wand 310 includes four sides 311a-d each including one of four descriptive legends; the R & I legend 314d, the Replace legend 314c; the Paint legend 314b and the Repair legend 314a. As with the other wands described herein, each side of the wand or a portion thereof also can include a color code that is appropriate for and associated with the descriptive legend being shown such as that described herein.

The proximal end portion of such a wand includes an end portion 322 and a holding region 320. The end portion 322 is configured and arranged so that it in combination with the holding region forms a stop, much like a baseball bat, to restrain axial movement of the user's hand. The holding region 320 is a depressed region that is formed so as to provide any of a number of configurations that provide an appropriate surface for gripping the wand while the user is pointing the wand towards the vehicle to identify a damaged area and to provide an indication of the corrective action or procedure category. In illustrative embodiments, the holding region is configured so as to form a cylindrical member having a diameter that approximates the cross-section or side to side dimension of the square portion of the wand.

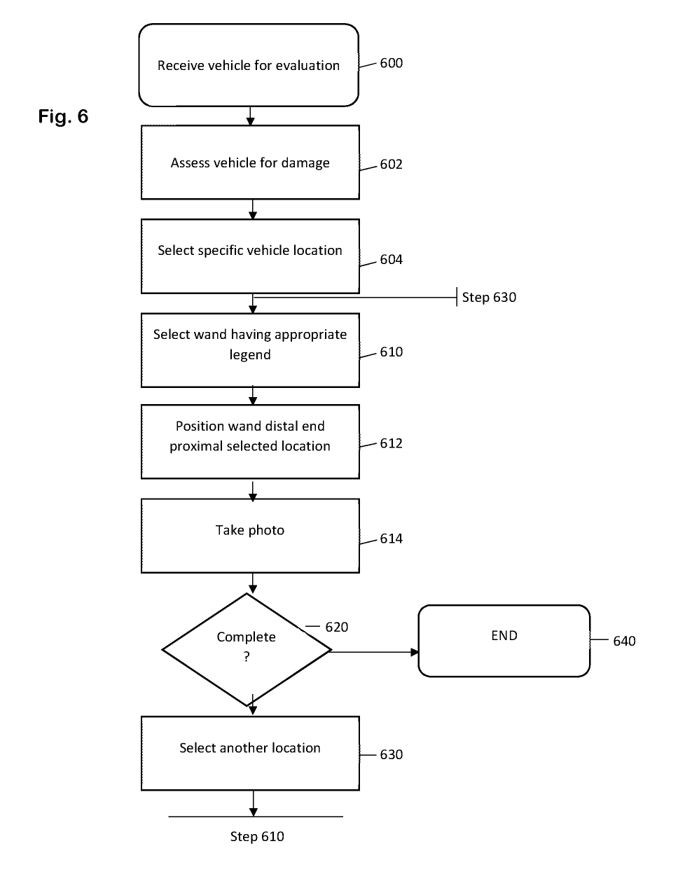

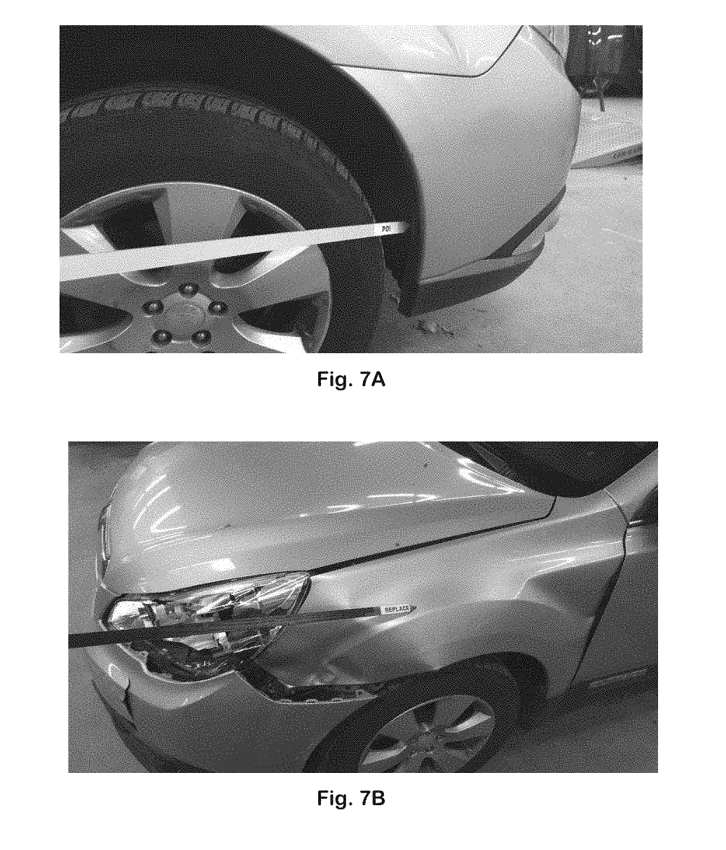

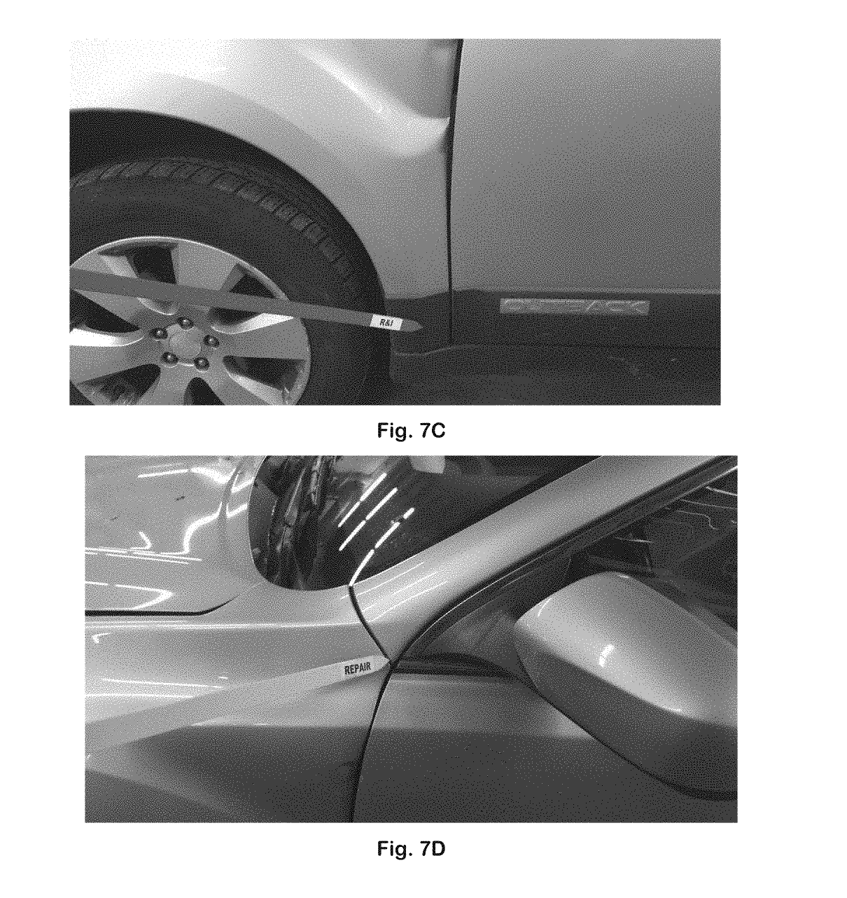

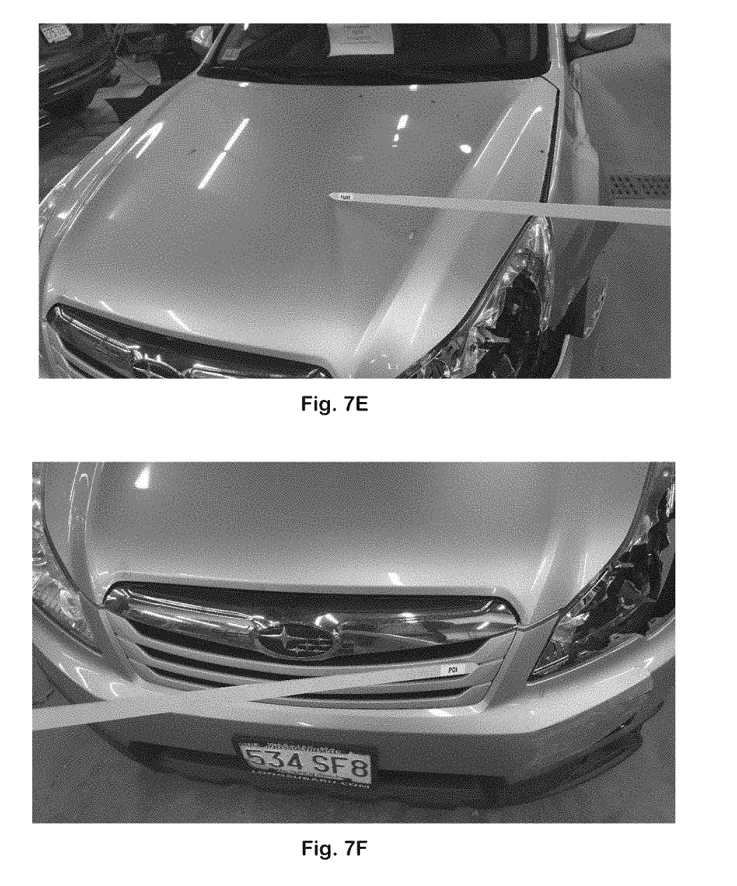

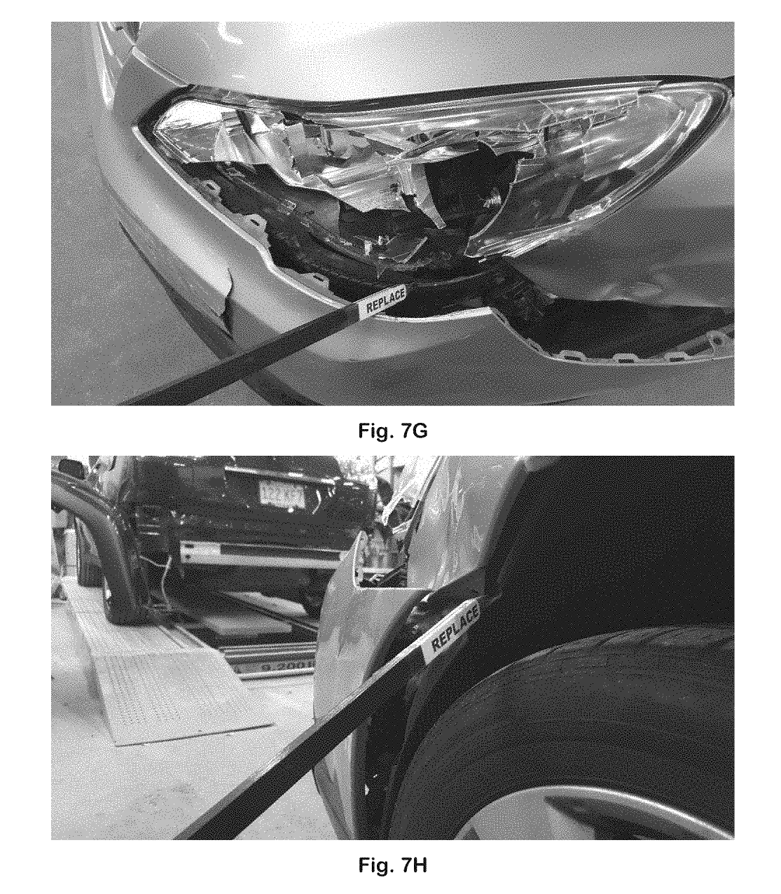

Referring now to FIG. 6 there is shown a high level process diagram or flow diagram of a methodology according to the present invention. As indicated herein such methods of the present invention and recited herein may be carried out in any order of the recited events which is logically possible, as well as the recited order of events. Reference also shall be made to one or more of FIGS. 7A-I which are various illustrative views showing use of the device or tool of the present invention to identify parts, regions or areas of a motor vehicle and categorizing the possible repair technique, repair procedure, corrective action or the like when taking photos of the identified vehicle part, region, or area.

FIG. 7A depicts use of a wand 110 having a POI or Point of Interest legend 114a that is arranged so the pointed end 116 is pointing at the inner wheel well of a motor vehicle and so the POI legend is visible. This also shows the advantageous effect of using a wand according to the present invention as most inner wheel wells are now made of a non-magnetic materials (plastic) and as the inner wheel well is not generally readily visible to one standing away from the vehicle. In this way the appraiser or shop representative can identify a point on the motor vehicle where there is possible damage or misalignment but it is unclear. It may be necessary for example, to remove parts of the vehicle to determine if and what damage may have occurred.

FIG. 7B depicts the use of a wand having a Replace legend 114c that is arranged so the pointed end 116 is pointing or aimed at the left front fender of a motor vehicle and so that the Replace legend is visible. In this way, one can determine from the photo taken according to the present invention that the identified part is damaged and that the suggested corrective action is to remove and replace the damaged part with a new part.

FIG. 7C depicts the use of a wand having a Remove and Install (R&I) legend 114d that is arranged so the pointed end 116 is pointing or aimed at a piece of black trim of a motor vehicle and so the R&I legend is visible. In this way, one can determine from the photo taken according to the present invention that the identified part should be removed and installed or re-installed as the procedure category or corrective action.

FIG. 7D depicts the use of a wand having a Repair legend 114b that is arranged so the pointed end 116 is pointing or aimed at an area of the motor vehicle that requires repair (e.g., gap is not uniform between adjoining parts). In this way, one can determine from the photo taken according to the present invention that the identified area or parts adjoining each other need to be repaired (e.g., adjusted) so that identified area is returned to its manufactured condition (e.g., gap is made uniform).

FIG. 7E depicts the use of a wand having a Paint legend 114e that is arranged so the pointed end 116 is pointing or aimed at the hood of a motor vehicle and so the Paint legend is visible. In this way, one can determine from the photo taken according to the present invention that the hood needs to be painted, refinished, blended, or clear coated as the procedure category or corrective action. This is particularly so as one of the front fenders is to be replaced.

FIG. 7F depicts another use of a wand 110 having a POI or Point of Interest legend 114a. In this depiction the pointed end 116 is pointing at towards a portion of the front grill of the motor vehicle and so the POI legend is visible. Such a part or region of the motor vehicle is typically made of a nonmetallic material such as plastic.

FIG. 7G depict another use of a wand having a Replace legend 114c. In this depiction the pointed end 116 is pointing or aimed at the light or headlight assembly of the motor vehicle and so that the Replace legend is visible. In this way, one can readily determine from the photo taken according to the methodology of the present invention that the identified part is damaged and that the suggested corrective action is to remove and replace the damaged part with a new part.

FIG. 7H depicts another use of a wand having a Replace legend 114c. In this depiction the pointed end 116 is pointing or aimed at the inner wheel well for the left front fender of a motor vehicle and so the Replace legend is visible. In this way, one can readily determine from the photo taken according to the methodology of the present invention that the identified part is damaged and that the suggested corrective action is to remove and replace the damaged part with a new part.

FIG. 7I depicts another use of a wand having a Replace legend 114c. In this depiction, the pointed end 116 is pointing or aimed at a part located in the engine compartment of another motor vehicle and so that the Replace legend is visible. In this way, one can readily determine from the photo taken that the identified part is damaged and that the suggested corrective action is to remove and replace the damaged part with a new part. This photo depiction is illustrative of the use of the methodology of the present invention by a shop representative or later assessment by an appraiser after access is made to the engine compartment. In front end type of accidents, the appraiser will avoid accessing the engine compartment to avoid the possibility the hood cannot be re-secured.

FIGS. 7A-I also describe how the wand and methodology of the present invention can be utilized to quickly and easily identify damaged parts, areas or regions as well as providing documentary evidence in the form of photographs, digital photos or the like od such parts, areas and regions including proposed procedure categories or correction actions to such parts, regions or areas. These figures, such as for example, FIGS. 7B-D, G and H, also illustrate how the wands with different legends can be used to identify a procedure category or corrective actions for individual parts or areas of a vehicle that has been damaged in the photos taken in connection with actions by the appraiser or shop representative.

In this way, the devices or tools 100 of the present invention can be used in combination with the below described method(s) of the present invention to document using photos, such as digital photos, the condition of various parts, areas or regions of a vehicle such as a motor vehicle. Such photos, in particular digital photos, also can be used in connection with an insurance claim for any damage to the vehicle resulting from collisions or accidents. Such devices and tools of the present invention also can be adapted for use in connection with documentation of the conditions of other vehicles such as construction or off-road vehicles, trucks, trains or airplanes requiring repair, maintenance or the like.

The methodology of the present invention, is described hereinafter using for illustration damage to a motor vehicle such as automobiles, trucks and the like as it is particularly suited for dealing with the practices for settling and dealing with insurance claims arising out of collisions, accidents, vandalism and the like for such motor vehicles. However, and as indicated herein this shall not be limiting as it is within the scope of the preset invention to adapt the devices, tools and methods of the present invention for use with the repair, maintenance and the like for other types of vehicles. Also, it is within the scope of the present invention to adapt the devices, tools, and method of the present invention for use in dealing with the identification and categorization of vehicle damage when vehicle insurance is not involved.

As indicated herein after a motor vehicle with insurance has become damaged as a result of an accident, collision, vandalism or the like, the process initially starts by having an appraiser or other authorized person view the damaged vehicle. This is done so the appraiser can determine the extent of damage to the vehicle and generate an estimate for dealing with the damage. Such a process can include the taking of pictures to substantiate the assessment made by the appraiser. Afterwards, the vehicle is typically given to a repair facility to deal with the damage and return the vehicle to a safe driving condition. As also indicated herein, if the motor vehicle is covered by insurance the appraiser may be related to the insurance company or a person authorized by the insurance company.

As part of this repair process, the repair facility or shop evaluates the vehicle for any other damage not identified by the appraiser as well as documenting the condition of the vehicle and the corrective action they believe should be taken. If additional damage is identified or there is a discrepancy with the corrective action(s) identified by the appraiser and repair facility/shop, an appraiser meets with the repair facility to view and discuss these matters. Thereafter, another estimate is generated at least identifying the additional damage and corrective actions therefor. Such a process can include the taking of additional pictures to substantiate the additional assessment.

Thus, the process starts, Step 600 with receiving a vehicle (e.g., a damaged vehicle) for evaluation such as by an appraiser or the repair facility/shop. As is known in the art, unless the vehicle damage has made the vehicle un-drivable, the vehicle owner brings the vehicle to the appraiser or repair shop for them to assess the condition of the vehicle. If the vehicle is not drivable, then the appraiser would travel to the location where the vehicle was towed to.

The appraiser or authorized person at the repair shop makes an initial assessment of the condition of the damaged vehicle, Step 602. This is done so they can generally determine the extent of damage resulting from the collision or accident. In this regard, they also can review any information provided by the driver(s) as to the accident or collision. Damage to the vehicle that is unrelated to the collision or accident may be evaluated for purposes of determining the value of the car pre-collision.

Such unrelated damage can be identified according to the present invention by pointing at the damaged area, part or region using a finger, hand or arm of the person taking the photo. This particular technique is likely to lead to less confusion because the method of identification is different from the technique used to identify damage relating to the accident, collision or vandalism. Alternatively, a wand with an appropriate descriptive legend (e.g., unrelated) can be used to identify such unrelated areas. Such a wand also can include a color code that is different from that used to identify damage relating to the collision, accident or vandalism. For example, the color code can include stripes of different colors.

As described hereinafter, this process according to the methods of the present invention is taken so appraiser or authorized person can identify the damaged parts, areas or regions of the vehicle and categorize the procedure category or corrective action involved with the identified parts, areas or regions. As also further described herein, this process also involves the use of photography, in particular digital photography to identify the damaged parts, areas and regions of the vehicle and further identify the procedure category or corrective action involved with the identified parts, areas or regions.

According to an embodiment of the present invention, the appraiser or authorized person takes photos of the damaged parts, area or regions of the motor vehicle so as to identify the damaged parts, area or regions of the motor vehicle and provide visual reference to the damage. Such a process is done without the use of the device/tool of the present invention. In this way, the appraiser or authorized person has two sets of photos identifying damage. During this process, the appraiser or authorized person also can identify the unrelated damage as described above. Thereafter, the appraiser or authorized person then would proceed with the identification and categorization of damage as hereinafter described. It should be noted that these photos of damage parts, areas or regions can be performed after the below described process is completed.

According to the methods of the present invention, the appraiser or authorized person next selects a specific vehicle location (e.g., part, area or region) that has been damaged or requires some corrective action, Step 604. Typically, there is more than one part, area or region of the motor vehicle which has been damaged, requires some corrective action or falls into one of the procedure categories as described above. Thus, the appraiser or authorized person starts at a given location, the selected vehicle location and then proceeds from there as described further herein.

After selecting the specific vehicle location, the appraiser or authorized person next assesses the motor vehicle to select the wand 110, 210 or side 311a-d of the wand 310 having the appropriate legend corresponding to the procedure category, corrective action or the like that should be taken for the part, area or region to be identified, Step 610. More specifically, the appraiser or authorized person next assesses the motor vehicle and determine what part, area or region at the location is being specifically identified and what procedure category, corrective action or the like from those legends 114a-e listed on the one or more wands 110, 210 comprising the device or tool 100 correspond to the action that should be taken for the part, area or region to be identified. In the case of the wand 310 shown in FIGS. 5A-E, such selecting comprises identifying the side 311a-d of the wand having the legend 314a-d correspond to the action that should be taken for the part, area or region to be identified.

The appraiser or authorized person next positions the wand 110, 210 that was selected or the side 311b-e of the wand 310 that was selected and positions the distal end 112 of the wand 110, 210, 310 proximal the selected vehicle location, Step 612. Such positioning also more specifically includes positioning the pointed end 116 of the distal end so it is aimed at or pointing towards the selected vehicle location. Further such positioning further includes positioning the wand so that the appropriate descriptive legend is visible when taking a photo of the selected vehicle location.

After positioning the wand, the appraiser or authorized person next takes a photo of the selected vehicle location including the part, area or region to be identified and of the selected wand, Step 614. More specifically, the appraiser or authorized person uses the selected wand to determine an appropriate distance between the digital camera or smartphone and the selected vehicle location and to appropriately locate the digital camera or smartphone and take the photo. As indicated herein, such taking of a photo preferably includes taking a photo of the wand pointing at the part, area or region of the vehicle to be identified and so that the descriptive legend is visible in the photo. As described hereinabove, FIGS. 7A-I provide a number of examples of such positioning, Step 612 and photo taking, Step 614.

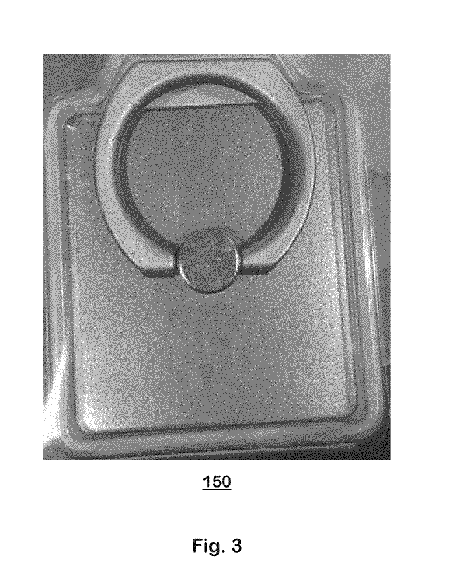

In this regard, the appraiser or authorized person also can use a device for holding the smartphone, digital camera or device for acquiring an image or photo. For example, the appraiser or authorized person when using a smartphone or the like can secure an exemplary mobile phone stent 150 such as that shown in FIG. 3, to the smartphone so they can securely hold the smart phone and the device or tool of the present invention while taking a photo. Alternatively, when using a digital camera, a mono or uni pod could be used.

After taking the photo, the appraiser or authorized person determines if the process of identifying and categorizing damage to the vehicle is complete or not, Step 620. If the appraiser or authorized person has identified and categorized all of the damaged parts, areas or regions of the motor vehicle (Yes, Step 620), then the process ends, Step 640. Thereafter, the appraiser or authorized person takes the next appropriate action in accordance with other procedures.

If on the other hand the appraiser or authorized person has not identified and categorized all of the damaged parts, areas or regions of the motor vehicle (No, Step 620), then the process proceeds with selecting another vehicle location and returning to process Step 610 so as to document the identification and categorizing (Steps 610-614). For example and as shown in FIGS. 7B-D, G and H, while the left front of the vehicle was damaged, the damage extended to the left front head light assembly, the left front fender, the inner wheel well, that gaps between the fender and driver's side door and related trim pieces as well as to the appropriate painting of the hood. Thus, the identification and categorizing process includes separately identifying each of these parts or areas of the motor vehicle and also providing a procedure category or corrective action for each identified part or area.

The wands, device, process and methods of the present invention are particularly advantageous as the wands and devices are simple for anyone to identify specifics parts, regions or areas of the motor vehicle; are very portable and mobile allowing in field use and allows for touch free repair identification—one does not have to write, or attach anything on the vehicle (also don't even need to clean the vehicle). Such wands, devices, process and/or methods of the present invention allows one to organize and keep track of records of the repair process and removes guesswork (i.e., no need to guess what a picture was taken for). Such devices, wands, process and methods generally causes one to take better photos and does not involve the need for complex instructions or education. In contrast to conventional or known devices and/or methods, there is no need to purchase markers, stickers, or magnets over and over again. Further such devices and wands are constructed and made of materials that are capable of enduring both indoor and outdoor climates and be damage resistant (e.g., won't chip, break, or shatter when dropped). Also such wands, device, process and methods are adaptable so that they can be used in different languages.

As indicated hereinabove, the wands, device, process and methods of the present invention are particularly advantageous and effective for identification of specifics parts, regions or areas of the motor vehicle that have become damaged using a touch free repair identification—process that does not require one to write, or attach anything on the vehicle/motor vehicles. In addition to identifying such damage, such wands, device, process and methods also provide a mechanism by which one not only can identify the damage but also can provide a descriptive legend that also identifies a repair modality or provide a message that can be used to identify a repair modality or provide other relevant information (e.g., a point of interest). In sum, such wands, device, process and methods of the present invention are information laden and the photos, digital images or the like acquired for identifying and locating damage parts, regions or areas of a vehicle also are usable to facilitate the process of repairing the damaged vehicle.

In yet further aspects of the present invention there is featured a method which uses the information laden photographs, digital images and/or other information obtained using the methods and devices described hereinabove in connection with the repair of a damaged vehicle/motor vehicle. More specifically, as the photographs or digital images identify the damaged part, region or area of the vehicle/motor vehicle as well as identifying the repair modality by means of the descriptive legend provided on the wand/device, also shown in the photo/digital image, the body shop or repair shop (“body/repair shop”) such as a repair technician thereof can readily determine what parts/areas/regions of the vehicle are to be replaced, repaired, removed and installed or as otherwise described herein. Such a determination can be made before they begin to work on the vehicle, including even before the vehicle enters the shop.

This advantageously allows the body or repair shop to order parts, materials and the like in advance so as to facilitate the repair process (e.g., repair not unduly delayed because of parts delivery). In addition, such information also allows the body/repair shop to determine in advance the resources they will utilize in connection with the vehicle repair as well as to develop a plan for the repair of the vehicle. In this way, the body/repair shop is in a position to be better informed as to the needs and requirements of a repair process even in cases where they may not be in physical possession of the vehicle.

More particularly, such a repair method includes receiving the photographs or digital images identify the damaged part, region or area of the vehicle/motor vehicle, the identified repair modality as designated by the descriptive legend provided on the wand/device, also shown in the photo/digital image, and any other information being made available to the body/repair shop relating to the repair activities including any instruction from the insurance provider. Such photos, digital images and the like as well as such other information can be provided by the appraiser, insurance company or other person who had assessed the damage to the vehicle using the wands, devices, process and/or methods of the present invention as hereinabove described. This includes the body/repair shop where the repair work is to take place.

Such a method further includes the body/repair shop performing an initial evaluation of the photographs, digital images or the like as well as the provided other information that were obtained to determine the damage and the repair modality as identified on the provided photos, digital images or the like. This can include electronic transfer and/or printing out one or more physical copies of such photos, digital images or the like. In this way, the body/repair shop can determine from the photos, digital images or the like as well as any additional other information being provided what parts, areas, regions of the vehicle/motor vehicle, for example, are to be replaced, what ones should be removed, repaired and installed, what ones would require painting and any other described corrective actions. While this can be done without the vehicle, such actions also can be taken when the vehicle is in the possession of the body/repair shop.

From such information, photos, digital images and/or the like the body/repair shop can determine parts and material requirements and the resources (e.g., tools and equipment) needed to perform the repair of the damaged vehicle. Such photos, digital images, the like also and the other information can be used by the body/repair shop to determine a plan for the vehicle repair. Such a plan can include the ordering of the actions to be take such as the removal or parts, areas of regions of the vehicle that are to be replaced or installed after repairing/painting.

As indicated herein, when a body/repair shop begins the repair process including deconstruction/disassembly of the vehicle/motor vehicle it is not uncommon for the body/repair shop to discover additional damage to the vehicle. Thus, in addition to identifying such additional damage using the wands, devices, process and methods of the present invention, the body/repair shop using this additional information can appropriately modify the repair plan as well as ordering any additional parts and/or materials for repairing such additional damage.

In further embodiments/aspects, a repair technician can make reference to photos, digital images and any other related or relevant information to determine the expected corrective actions for the identified damage during the repair process. Such reference to the photos, digital images or the like provides visual information the technician can easily refer to facilitate their repair actions/activities relative to the vehicle. This facilitation also reduces the potential for rework do to mistake or misunderstanding as well as any related time and money lost due to such rework.

The body/repair shop also can use the photos, digital images or the like as well as any additional information acquired to develop checklists, punch lists or the like that can be used by the body/repair shop or the repair technician in determining if the repair process has been completed.

Further, the repair process or methodology of the present invention can further include taking photos, digital images and the like of the repaired vehicle at vehicle locations corresponding to where damage had been identified previously to provide visual documentation of the corrective actions taken. In this way, the process from appraisal through and including repair can provide visual documentation as to what was damaged and what the vehicle looks like following repair.

Although a preferred embodiment of the invention has been described using specific terms, such description is for illustrative purposes only, and it is to be understood that changes and variations may be made without departing from the spirit or scope of the following claims.

### INCORPORATION BY REFERENCE

All patents, published patent applications and other references disclosed herein are hereby expressly incorporated by reference in their entireties by reference except insofar as the subject matter may conflict with that of the present invention (in which case what is present herein shall prevail). Nothing herein is to be construed as an admission that the present invention is not entitled to antedate such material by virtue of prior invention.

### EQUIVALENTS

Those skilled in the art will recognize, or be able to ascertain using no more than routine experimentation, many equivalents of the specific embodiments of the invention described herein. Such equivalents are intended to be encompassed by the following claims.

What is claimed is:

1. A method for identifying and categorizing damage to a motor vehicle comprising the steps of:
selecting one of a part, area or region of a motor vehicle to identify one of the part, region or area;
selecting a given wand from a device comprising at least one wand, each of the at least one wand having a descriptive legend proximal a distal end of the wand;
positioning the distal end of the given wand proximal the selected part, region or area; and
photographing the selected part, region or area of the vehicle while maintaining the distal end of the given wand and the descriptive legend within the field of view of a device that is configured to acquire images.

2. The method of claim 1, wherein the device comprises a plurality of wands, where the descriptive legend is different for each wand.

3. The method of claim 1, wherein the device comprises a multiplicity of wands, where the descriptive legend is different for each wand.

4. The method of claim 1, further comprising the steps of:
determining after said photographing if there is another part, area or region of the vehicle to identify;
if said determining determines that there is another part, region or area to identify then repeating said steps of selecting another wand having a descriptive legend that relates to the another part, area or region to identify, positioning the distal end of the another wand proximal the selected part, region or area; and photographing the selected part, region or area of the vehicle while maintaining the distal end of the another wand within the field of view of the device taking the photograph.

5. The method of claim of claim 4, further comprising ending the process of identifying and categorizing the one or more parts, areas, and regions of the vehicle, if is determined that there is no more parts, regions or areas to identify.

6. The method of claim 1, wherein the wand has a predetermined length and said method further comprises the step of positioning the image acquiring device based on the using the predetermined length of the wand.

7. The method of claim 1, wherein the image acquiring device comprises one of digital camera or a smartphone.

8. A tool for identifying and categorizing damage to a motor vehicle comprising:
at least one wand; and
wherein each of the at least one wand includes a descriptive legend proximal a distal end of the wand.

9. The tool of claim 8, further comprising a plurality of wands, where the descriptive legend is different for each wand.

10. The tool of claim 8, further comprising a multiplicity of wands, where the descriptive legend is different for each wand.

11. The tool of claim 8, further comprising an image acquiring device.

12. The tool of claim 11, wherein each wand has a predetermined length, the predetermined length being established for positioning the image acquiring device at a desired location with respect to the part, area or region to be identified using the tool.
